(19) United States
(12) Patent Application Publication
(10) Pub. No.: US 2025/0118461 A1
(43) Pub. Date: Apr. 10, 2025

(54) ELECTRONIC COMPONENT AND METHOD FOR MANUFACTURING ELECTRONIC COMPONENT

(71) Applicant: Murata Manufacturing Co., Ltd., Nagaokakyo-shi (JP)

(72) Inventors: Daisho TSUBOKAWA, Nagaokakyo-shi (JP); Tomoya OOSHIMA, Nagaokakyo-shi (JP); Yuuta HOSHINO, Nagaokakyo-shi (JP)

(73) Assignee: Murata Manufacturing Co., Ltd., Nagaokakyo-shi (JP)

(21) Appl. No.: 18/983,399

(22) Filed: Dec. 17, 2024

Related U.S. Application Data
(63) Continuation of application No. PCT/JP2023/030254, filed on Aug. 23, 2023.

(30) Foreign Application Priority Data
Jan. 27, 2023 (JP) 2023-011007

(51) Int. Cl. H01C 1/034; C03C 1/00; H01C 1/142; H01C 7/04; H01C 17/02; H01C 17/28

(52) U.S. Cl. CPC H01C 1/034; C03C 1/006; H01C 1/142; H01C 7/041; H01C 17/02; H01C 17/281; C03C 2201/60; C03C 2203/26

(57) ABSTRACT

An electronic component includes a base body including a plurality of voids, a protective material covering a part or a whole of an outer surface of the base body, and an external electrode covering a part of an outer surface of the protective material. The protective material is glass containing a silane compound having a carbon chain with 3 or more carbon atoms. The protective material includes a filling portion occupying at least some of the voids, and a film portion covering the outer surface of the base body.

### CROSS-REFERENCE TO RELATED APPLICATIONS

This application is a continuation of international application no. PCT/JP2023/030254, filed Aug. 23, 2023, which claims priority to Japanese application no. 2023-011007, filed Jan. 27, 2023. The entire disclosures of these applications are hereby incorporated by reference.

### TECHNICAL FIELD

The present disclosure relates to an electronic component and a method for manufacturing an electronic component.

### BACKGROUND ART

The electronic component described in Patent Document 1 includes a base body, a protective material covering an outer surface of the base body, and an external electrode covering a part of an outer surface of the protective material. The base body is porous and has voids therein. In addition, Patent Document 1 discloses a glass film as an example of a protective material.

### PRIOR ART DOCUMENT

### Patent Document

Patent Document 1: Japanese Patent No. 6034553

### SUMMARY

### Problem

The glass film as a protective material disclosed in Patent Document 1 is likely to remain on the outer surface of the base body in the process of manufacturing the glass film. Therefore, it is difficult to fill voids in the base body with glass. As a result, voids are likely to remain in the base body, and cracks and the like are likely to occur in the base body with the void as a starting point.

### Solution

In order to solve the above problems, one aspect of the present disclosure is an electronic component including: a base body including a plurality of voids; a protective material covering a part or a whole of an outer surface of the base body; and an external electrode covering a part of an outer surface of the protective material, wherein the protective material is glass containing a silane compound having a carbon chain with 3 or more carbon atoms and includes a filling portion occupying at least some of the voids and a film portion covering the outer surface of the base body.

One aspect of the present disclosure is a method for manufacturing an electronic component, the method including: preparing a base body having a plurality of voids therein; charging the base body into a reaction vessel; charging a solution containing a metal alkoxide or a metal alkoxide precursor and a silane compound having a carbon chain with 3 or more carbon atoms into the reaction vessel; and hydrolyzing and condensation-polymerizing the metal alkoxide on an outer surface of the base body and forming a protective material including a filling portion occupying the plurality of voids and a film portion covering the outer surface of the base body.

According to the above configuration, the protective material is glass containing a silane compound. Since the silane compound has a carbon chain with 3 or more carbon atoms, glass easily enters the voids in the base body in the process of manufacturing the protective material. As a result, the protective material has not only a film portion covering the outer surface of the base body but also a filling portion filled in the voids. When the voids of the base body are filled with the filling portion as a part of the protective material as described above, cracks and the like can be prevented from occurring in the base body with the void in the base body as a starting point.

### Advantageous Effect

By filling the voids in the base body, the strength of the base body can be improved.

### BRIEF EXPLANATION OF DRAWINGS

FIG. 1 is a perspective view of an electronic component.

FIG. 2 is a side view of the electronic component.

FIG. 3 is a sectional view taken along the line 3-3 in FIG. 2.

FIG. 4 is an enlarged sectional view of the vicinity of a film portion of an electronic component.

FIG. 5 is an explanatory diagram illustrating a method for manufacturing an electronic component.

FIG. 6 is an explanatory diagram illustrating the method for manufacturing an electronic component.

FIG. 7 is an explanatory diagram illustrating the method for manufacturing an electronic component.

FIG. 8 is an explanatory diagram illustrating a method for manufacturing the electronic component.

FIG. 9 is an explanatory diagram illustrating a method for manufacturing the electronic component.

### DETAILED DESCRIPTION

### <Embodiment of Electronic Component>

Hereinafter, an embodiment of the electronic component will be described with reference to the drawings. In the drawings, components may be enlarged for the sake of easy understanding. In some cases, the dimension ratio of a component differs from an actual dimension ratio or a dimension ratio in another drawing.

### (Overall Configuration)

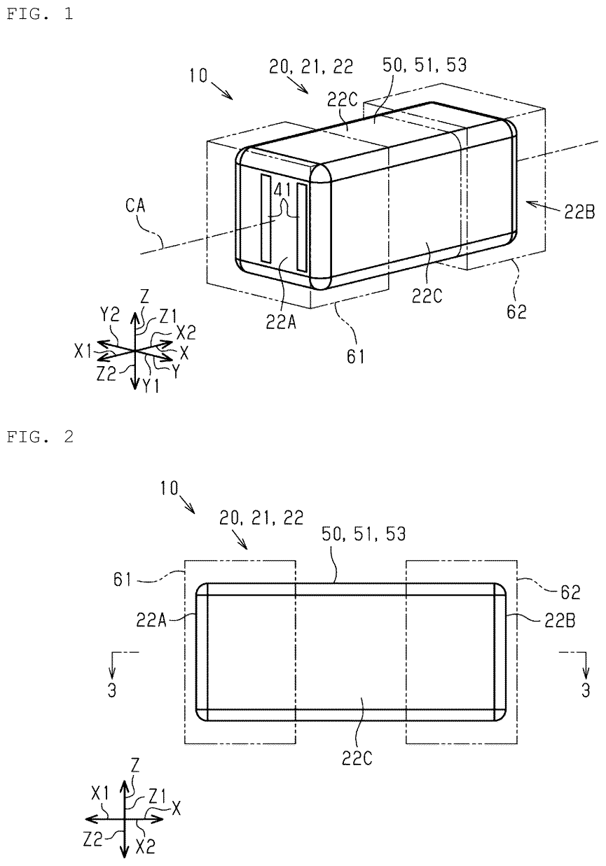

As shown in FIG. 1, an electronic component 10 is, for example, a surface mount negative characteristic thermistor component to be mounted on a circuit board or the like. It is to be noted that the negative characteristic thermistor component has a characteristic that the resistance value is decreased as the temperature is increased.

The electronic component 10 includes a base body 20. The base body 20 has a substantially quadrangular prism shape and has a central axis CA. Hereinafter, an axis extending along the central axis CA is referred to as a first axis X. One of the axes orthogonal to the first axis X is defined as a second axis Y. An axis orthogonal to the first axis X and the second axis Y is defined as a third axis Z. Further, one of the directions along the first axis X is defined as a first positive direction X1, and a direction opposite to the first positive direction X1 among the directions along the first axis X is defined as a first negative direction X2. One of the directions along the second axis Y is defined as a second positive direction Y1, and the direction opposite to the second positive direction Y1 among the directions along the second axis Y is defined as a second negative direction Y2. Further, one of the directions along the third axis Z is defined as a third positive direction Z1, and a direction opposite to the third positive direction Z1 among the directions along the third axis Z is defined as a third negative direction Z2.

An outer surface 21 of the base body 20 has six planes 22. The term “surface” of the base body 20 as used herein refers to a surface that can be observed as a surface when the entire base body 20 is observed. That is, for example, if there is a minute unevenness or step that cannot be seen unless a part of the base body 20 is enlarged and observed with a microscope or the like, it is expressed as a flat surface or a curved surface. The six planes 22 face different directions. The six planes 22 are roughly divided into a first end surface 22A facing the first positive direction X1, a second end surface 22B facing the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

In the outer surface 21 of the base body 20, a boundary portion between two adjacent planes 22 and a boundary portion between three adjacent surfaces are curved surfaces. That is, the corners of the base body 20 are rounded. In FIGS. 1 and 2, an outer surface 53 of a film portion 51 in a protective material 50 to be described later is denoted by the same reference numeral as the outer surface 21 of the base body 20.

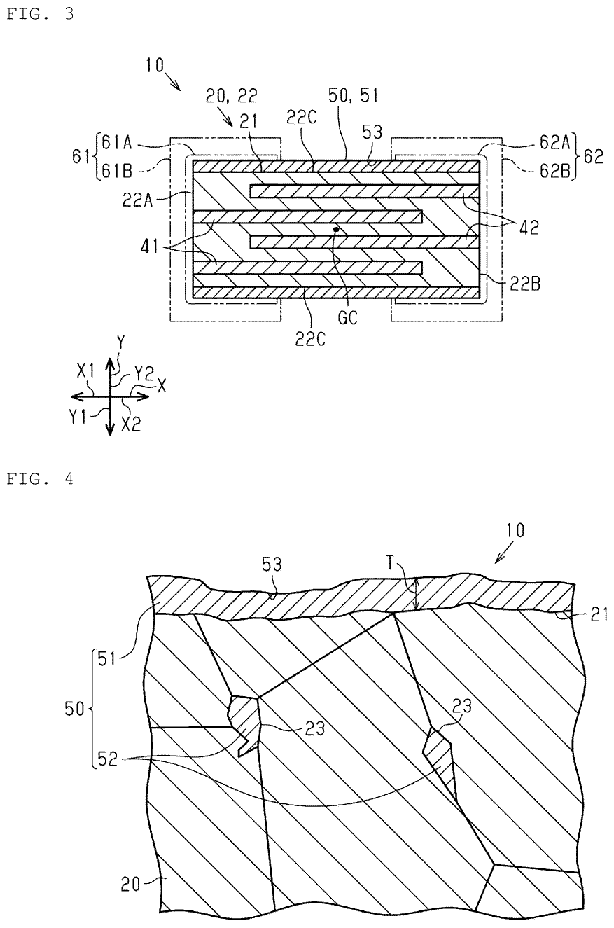

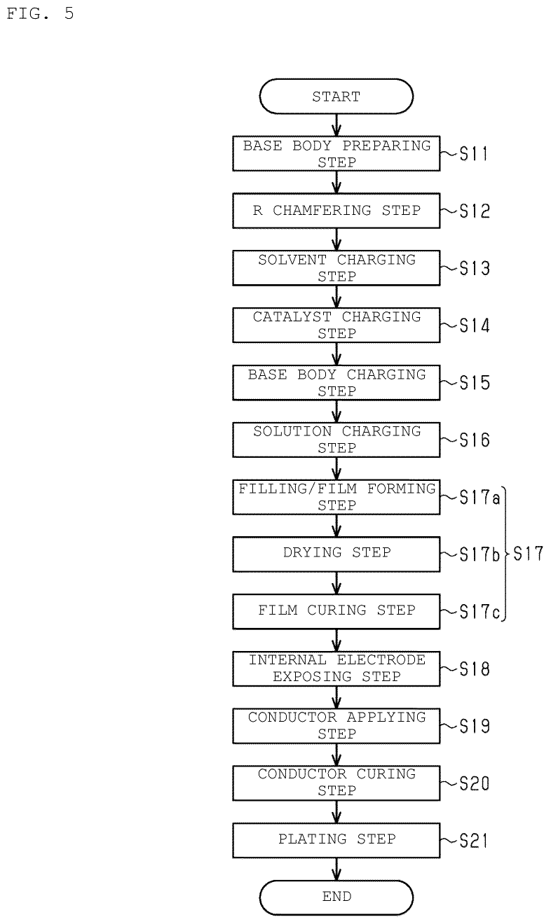

As illustrated in FIG. 2, the base body 20 has a dimension in the direction along the first axis X larger than a dimension in the direction along the third axis Z. As illustrated in FIG. 3, the base body 20 has a dimension in the direction along the first axis X larger than a dimension in the direction along the second axis Y. The material of the base body 20 is a ceramic obtained by firing a metal oxide containing one or more elements selected from Mn, Fe, Ni, Co, Ti, Ba, Al, and Zn as components. Therefore, as illustrated in FIG. 4, the base body 20 has a plurality of voids 23 therein. These voids 23 are mainly present at boundaries of grains constituting the base body 20 as a sintered body. In FIG. 3, illustration of the voids 23 is omitted.

Here, the ratio of the total volume of the voids 23 to the volume of the base body 20 is defined as a porosity. Note that the volume of the base body 20 includes the volume of the voids 23 in addition to the volume of the ceramic portion. When defined in this way, the porosity is 0.5% or more and 2.5% or less. A method of calculating the porosity is as follows. First, a region of 10 μm square in an arbitrary section of the base body 20 is imaged using an electron microscope. Then, a similar range is imaged in a plurality of sections, and an integrated value of the area of the voids 23 and an integrated value of the area of the imaging region of 10 μm square in the imaged plurality of images are obtained. Then, a value obtained by multiplying “the integrated value of the areas of the voids 23/the integrated value of the area of the imaging region” by 100 is the porosity. Therefore, in the present embodiment, the porosity is expressed in percentage.

As illustrated in FIG. 3, the electronic component 10 includes two first internal electrodes 41 and two second internal electrodes 42. The first internal electrodes 41 and the second internal electrodes 42 are embedded in the base body 20.

The material of the first internal electrode 41 is a conductive material. For example, the material of the first internal electrode 41 is palladium. The material of the second internal electrode 42 is the same as the material of the first internal electrode 41.

The first internal electrode 41 has a rectangular plate shape. The first internal electrode 41 has a principal surface orthogonal to the second axis Y. The second internal electrode 42 has the same rectangular plate shape as the first internal electrode 41. A main surface of the second internal electrode 42 is orthogonal to the second axis Y, as with the first internal electrode 41.

The dimension of the first internal electrode 41 in the direction along the first axis X is smaller than the dimension of the base body 20 in the direction along the first axis X. As illustrated in FIG. 1, the dimension of the first internal electrode 41 in the direction along the third axis Z is approximately ⅔ of the dimension of the base body 20 in the direction along the third axis Z. The dimension of the second internal electrode 42 in each of the directions is the same as that of the first internal electrode 41.

As shown in FIG. 3, the first internal electrodes 41 and the second internal electrodes 42 are located in a staggered manner in the direction along the second axis Y. That is, the first internal electrode 41, the second internal electrode 42, the first internal electrode 41, and the second internal electrode 42 are arranged in this order from the side surface 22C facing the second positive direction Y1 toward the second negative direction Y2. In the embodiment, each of the internal electrodes has an equal distance therebetween in the direction along the second axis Y.

As illustrated in FIG. 1, the two first internal electrodes 41 and the two second internal electrodes 42 are both located at the center of the base body 20 in the direction along the third axis Z. On the other hand, as illustrated in FIG. 3, the first internal electrodes 41 are located deviated to the first positive direction X1. The second internal electrodes 42 are located deviated to the first negative direction X2.

Specifically, the end of the first internal electrode 41 on the first positive direction X1 side coincides with the end of the base body 20 on the first positive direction X1 side. That is, the end of the first internal electrode 41 on the first positive direction X1 side is exposed at the first end surface 22A of the base body 20. An end of the first internal electrode 41 on the first negative direction X2 side is located inside the base body 20 and does not reach an end of the base body 20 on the first negative direction X2 side. On the other hand, an end of the second internal electrode 42 on the first negative direction X2 side coincides with an end of the base body 20 on the first negative direction X2 side. That is, the end of the first internal electrode 41 on the first negative direction X2 side is exposed at the second end surface 22B of the base body 20. The end of the second internal electrode 42 on the first positive direction X1 side is located inside the base body 20 and does not reach the end of the base body 20 on the first positive direction X1 side.

As shown in FIG. 4, the electronic component 10 includes the protective material 50. The protective material 50 is insulating glass. The glass contained in the protective material 50 contains silicon dioxide and a silane compound having a carbon chain with 3 or more carbon atoms. The silane compound to be a material of the protective material 50 has one or more functional groups selected from an epoxy group, a mercapto group, an amino group, a vinyl group, and a methacrylic group. Specifically, the silane compound is 3-glycidoxypropyltrimethoxysilane (Hereinafter referred to as “GPTMS”). GPTMS has an epoxy group as a functional group.

As shown in FIG. 3, the electronic component 10 includes a first external electrode 61 and a second external electrode 62. In FIGS. 1 to 3, the first external electrode 61 and the second external electrode 62 are indicated by two-dot chain lines.

The first external electrode 61 includes a first base electrode 61A and a first metal layer 61B. The first base electrode 61A is laminated at a part of the outer surface 21 of the base body 20, including the first end surface 22A. Specifically, the first base electrode 61A covers the first end surface 22A of the base body 20 and covers a part of the four side surfaces 22C on the first positive direction X1 side from above the protective material 50. That is, the first base electrode 61A is a five-face electrode. In this embodiment, the material of the first base electrode 61A is a resin electrode. More specifically, it is a mixture of an organic resin and silver grains.

The first metal layer 61B covers the first base electrode 61A from the outside. Therefore, the first metal layer 61B is laminated on the first base electrode 61A. Although not shown in the drawing, the first metal layer 61B has a two-layer structure of a nickel layer and a tin layer in this order from the first base electrode 61A side. The first external electrode 61 is connected to an end of the first internal electrode 41 on the first positive direction X1 side.

The second external electrode 62 includes a second base electrode 62A and a second metal layer 62B. The second base electrode 62A is laminated on a part of the outer surface 21 of the base body 20 including the second end surface 22B. Specifically, the second base electrode 62A covers the second end surface 22B of the base body 20 and covers a part of the four side surfaces 22C on the first negative direction X2 side from above the protective material 50. That is, the second base electrode 62A is a five-face electrode. In this embodiment, the material of the second base electrode 62A is the same as the material of the first external electrode 61, and is a resin electrode. More specifically, it is a mixture of an organic resin and silver grains.

The second metal layer 62B covers the second base electrode 62A from the outside. Therefore, the second metal layer 62B is laminated on the second base electrode 62A. Specifically, similarly to the first metal layer 61B, the second metal layer 62B has a two-layer structure of nickel plating and tin plating. The second external electrode 62 is connected to a n end of the second internal electrode 42 on the first negative direction X2 side.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not laminated at the central portion in the direction along the first axis X, and the film portion 51 of the protective material 50 is exposed.

### (Protective Material)

As illustrated in FIG. 4, the protective material 50 includes a film portion 51 and a filling portion 52. The film portion 51 covers a part or the whole of the outer surface 21 of the base body 20. Specifically, the film portion 51 covers all the four side surfaces 22C of the outer surface 21 of the base body 20. At least some of the voids 23 are filled with the filling portion 52.

The average value of the thickness T of the film portion 51 is 20 nm or more and 1000 nm or less. The average value of the thickness T of the film portion 51 is calculated as follows. First, a section of the base body 20 is imaged using an electron microscope. For this captured image, a range of at least 10 μm or more in a direction along the outer surface 53 of the film portion 51 is set as a measurement range. Then, the sectional area of the film portion 51 in the measurement range is calculated by image processing. Then, by dividing the sectional area by the length of the measurement range in the direction along the outer surface 53 of the film portion 51, the average value of the thickness T of the film portion 51 in the measurement range is calculated.

The arithmetic average roughness of the outer surface 53 of the film portion 51 is 6 nm or more and 100 nm or less. The arithmetic average roughness of the outer surface 53 of the film portion 51 is calculated as follows.

First, a portion where there is no recess caused by falling off of ceramic grains, cracking and chipping of the base body 20, and the like is specified. Specifically, it is specified as follows. First, the base body 20 is cut in a direction orthogonal to the outer surface 21 of the base body 20 by focused ion beam processing or the like. Then, a section of the cut portion is imaged using an electron microscope or the like. In the imaged cut section, a tangent line circumscribing both of the outer surfaces 21 on both sides sandwiching the recess is drawn. A part of the tangent line may coincide with the outer surface 21 of the base body 20. At this time, the length from the tangent line to the inner surface of the recess in the direction orthogonal to the tangent line is defined as the depth of the recess in the cut section. Next, the base body 20 is further cut by a predetermined imaging pitch in a direction orthogonal to the cut section, and a new cut section is imaged. That is, a new cut section of the base body 20 substantially parallel to the cut section is imaged. Then, the depth of the recess in the new cut section is measured by the same method. In this manner, the imaging of the cut section of the base body 20 and the measurement of the depth of the recess are repeated. The largest value of the depths of the recesses in each cut section obtained as a result is taken as the maximum depth of the entire recesses. When the maximum depth at the recess is 10 times or more the arithmetic average roughness of the entire outer surface 21 of the base body 20, the recess is defined as the above “Recess caused by falling off of ceramic grains, cracking and chipping of base body 20, and the like”.

Next, a range of at least 10 μm or more in a direction along the outer surface 53 of the film portion 51 at a location where the “Recess caused by falling off of ceramic grains, cracking and chipping of base body 20, and the like” does not exist is defined as a measurement range. Then, in the measurement range, the arithmetic average roughness of the outer surface 53 of the film portion 51 is measured by a white interference method.

The filling portion 52 fills the void 23 existing at a position closest to the geometric center GC of the base body 20. As illustrated in FIG. 3, the geometric center GC of the base body 20 is a center point of the base body 20 including the first internal electrode 41 and the second internal electrode 42 located inside the base body 20. Here, as described later, a liquid to be a material of glass penetrates into the inside from the outer surface 21 of the base body 20, thereby forming the filling portion 52. Therefore, if the filling portion 52 fills the void 23 existing at the position closest to the geometric center GC of the base body 20, it can be considered that the filling portion 52 fills substantially all the voids 23 of the base body 20.

Whether or not the filling portion 52 fills the void 23 existing at the position closest to the geometric center GC of the base body 20 can be checked by imaging a section including the geometric center GC of the base body 20 using an electron microscope. Note that it is allowable to slightly deviate from the geometric center GC depending on processing accuracy or the like when cutting the base body 20. A deviation of about 5% of the dimension of the base body 20 in the direction along the first axis X from the geometric center GC in the strict sense is regarded as the geometric center GC. The same applies to the deviation in the direction along the second axis Y and the direction along the third axis Z.

As described above, since the filling portion 52 fills substantially all the voids 23 of the base body 20, when the ratio of the total volume of the filling portion 52 to the volume of the base body 20 is taken as the filling rate, the filling rate is substantially the same as the porosity. Therefore, similarly to the porosity, the filling rate is 0.5% or more and 2.5% or less. As described above, on the premise that the filling portion 52 fills substantially all the voids 23 of the base body 20, the porosity can be indirectly measured by measuring the filling rate.

The method of calculating the filling rate is the same as the method of calculating the porosity. First, a region of 10 μm square in an arbitrary section of the base body 20 is imaged using an electron microscope. Then, a similar range is imaged in a plurality of sections, and an integrated value of the area of the filling portion 52 and an integrated value of the area of the imaging region of 10 μm square in the imaged plurality of images are obtained. The filling rate is obtained by multiplying “the integrated value of the area of the filling portion 52/the integrated value of the area of the imaging region” by 100. Therefore, in the present embodiment, the filling rate is expressed as a percentage.

### (Method for Manufacturing Electronic Component)

Next, the method for manufacturing the electronic component 10 will be described.

As shown in FIG. 5, the method for manufacturing the electronic component 10 further includes a base body preparing step S11, an R chamfering step S12, a solvent charging step S13, a catalyst charging step S14, a base body charging step S15, a solution charging step S16, a protective material forming step S17, an internal electrode exposing step S18, a conductor applying step S19, a conductor curing step S20, and a plating step S21.

First, the base body preparing step S11 is performed. In the base body preparing step S11, a cuboid base body 20 having six planes 22 is prepared. That is, the base body 20 at this stage is in a state before R chamfering. For example, first, a plurality of ceramic sheets to be the base body 20 is prepared. The sheet has a thin plate shape. A conductive paste to be the first internal electrode 41 is laminated on the sheet. A ceramic sheet to be the base body 20 is laminated on the laminated paste. A conductive paste to be the second internal electrode 42 is laminated on the sheet. In this manner, the ceramic sheet and the conductive paste are laminated. Then, the base body 20 as an unfired laminate is formed by cutting into a predetermined size. Thereafter, the unfired base body 20 is fired at a high temperature to prepare the base body 20. The ceramic sheet has a plurality of voids therein. Therefore, the prepared base body 20 has a plurality of voids 23 therein.

Next, as illustrated in FIG. 5, the R chamfering step S12 is performed. In the R chamfering step S12, a curved surface is formed at a boundary portion between two adjacent planes 22 of the base body 20 prepared in the base body preparing step S11 and a boundary portion between three adjacent planes 22. For example, the corner of the base body 20 is subjected to R chamfering by barrel polishing, whereby a curved surface is formed at the boundary portion.

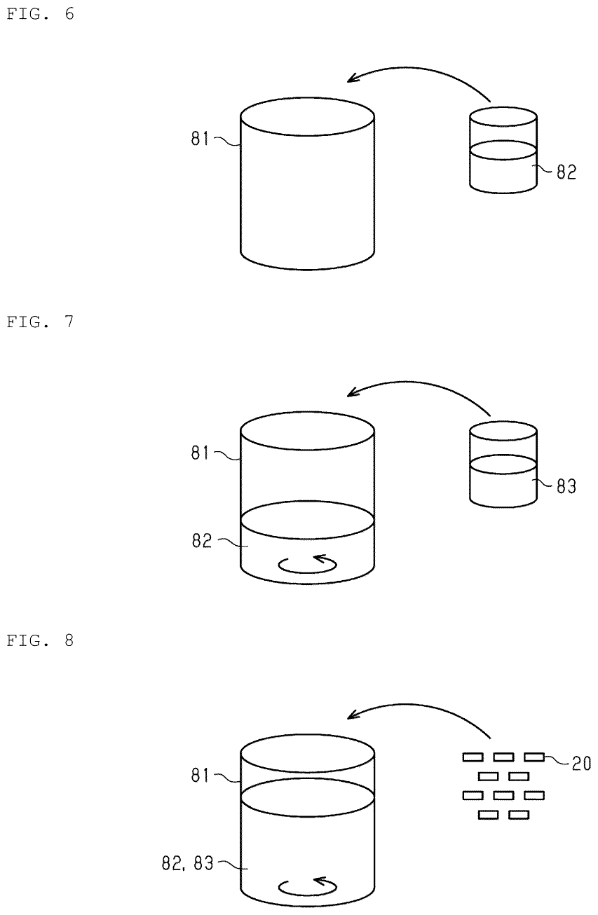

Next, as shown in FIG. 5, the solvent charging step S13 is performed. As illustrated in FIG. 6, in the solvent charging step S13, 2-propanol is charged as a solvent 82 into a reaction vessel 81.

Next, as shown in FIG. 5, the catalyst charging step S14 is performed. As illustrated in FIG. 7, in the catalyst charging step S14, first, stirring of the solvent 82 in the reaction vessel 81 is started. Then, ammonia water is charged into the reaction vessel 81 as an aqueous solution 83 containing the catalyst. The catalyst in this embodiment is a hydroxide ion, and functions as a catalyst that promotes hydrolysis of a metal alkoxide 84 described later.

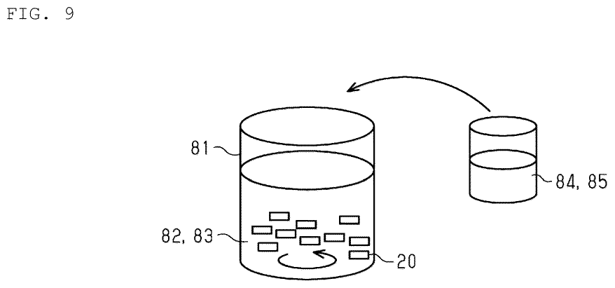

Next, as illustrated in FIG. 5, the base body charging step S15 is performed. As illustrated in FIG. 8, in the base body charging step S15, the plurality of base bodies 20 formed in advance in the R chamfering step S12 as described above are charged into the reaction vessel 81.

Next, as shown in FIG. 5, the solution charging step S16 is performed. As shown in FIG. 9, in the solution charging step S16, the metal alkoxide 84 and the silane compound 85 are charged into the reaction vessel 81. The metal alkoxide 84 is tetraethyl orthosilicate (Hereinafter, referred to as “TEOS”.) in a liquid state. TEOS is also referred to as tetraethoxysilane. The silane compound 85 is liquid GPTMS. GPTMS is charged at a weight ratio of 0.12 or more and less than 1 to TEOS. Specifically, GPTMS is charged at a weight ratio of about 0.43 to TEOS.

In the present embodiment, the amount of the solution containing the metal alkoxide 84 and the silane compound 85 charged in the solution charging step S16 is calculated based on the porosity of the base body 20 and the area of the outer surface 21 of the base body 20 charged in the base body charging step S15. Specifically, first, for one base body 20, the sum of the amount of the solution required to fill the void 23 of the base body 20 and the amount of the solution required to form the film portion 51 covering the outer surface 21 of the base body 20 is calculated. The required amounts of the metal alkoxide 84 and the silane compound 85 are calculated by multiplying the sum by the number of the base bodies 20 charged in the base body charging step S15.

Next, as illustrated in FIG. 5, the protective material forming step S17 is performed. In the protective material forming step S17, the protective material 50 including the filling portion 52 filling the plurality of voids 23 and the film portion 51 covering the outer surface 21 of the base body 20 is formed. The protective material forming step S17 can be discriminated into a filling/film forming step S17a, a drying step S17b, and a film curing step S17c when subdivided.

First, the filling/film forming step S17a is performed. In the filling/film forming step S17a, first, after the metal alkoxide 84 and the silane compound 85 are charged into the reaction vessel 81 in the solution charging step S16, stirring of the solvent 82 started in the solvent charging step S13 is continued for a predetermined time. As a result, the metal alkoxide 84 is hydrolyzed by hydroxide ions as a catalyst. The condensation polymerization reaction between the metal alkoxides 84 proceeds slowly as compared with the case where the silane compound 85 is not present. In other words, the grains of the metal alkoxide 84 generated by the condensation polymerization reaction remain small in volume per molecule over a relatively long period of time. Therefore, the metal alkoxide 84 adhering to the outer surface 21 of the base body 20 enters the voids 23 inside the base body 20 together with the solution. Thereafter, the condensation polymerization reaction of the metal alkoxide 84 proceeds in the voids 23, and the grains of the metal alkoxide 84 become large. As a result, the filling portion 52 is formed in the voids 23. On the other hand, when the metal alkoxide 84 is hydrolyzed, the hydrolyzed metal alkoxide 84 and silane compound 85 adhere to the outer surface 21 of the base body 20. The metal alkoxides 84 attached to the outer surface 21 of the base body 20 are condensed and polymerized to form the film portion 51. Therefore, in the filling/film forming step S17a, the protective material 50 including the sol-like film portion 51 and the sol-like filling portion 52 is formed by the liquid phase reaction in the reaction vessel 81.

Next, the drying step S17b is performed. In the drying step S17b, after the filling/film forming step S17a, the base body 20 is taken out from the reaction vessel 81 and dried. As a result, the sol-like protective material 50 is dried to become the protective material 50 including the gel-like film portion 51 and the gel-like filling portion 52.

Next, the film curing step S17c is performed. In the film curing step S17c, the base body 20 on which the gel-like protective material 50 is formed in the drying step S17b is fired at a temperature of 140° C. or more and 160° C. or less. Specifically, firing is performed at a temperature of 150° C. As a result, the gel-like film portion 51 and the gel-like filling portion 52 are cured. That is, the entire protective material 50 that has been in a gel state is cured. At this stage, the film portion 51 of the protective material 50 covers the entire outer surface 21 of the base body 20.

Next, the internal electrode exposing step S18 is performed. In the internal electrode exposing step S18, the film portion 51 covering the first end surface 22A and the second end surface 22B of the base body 20 is removed to expose the first internal electrode 41 and the second internal electrode 42. In the present embodiment, the film portion 51 is removed by cutting the entire region of the first end surface 22A and the entire region of the second end surface 22B of the base body 20 with a laser.

Next, the conductor applying step S19 is performed. In the conductor applying step S19, the conductor paste is applied to a part of the outer surface 21 of the base body 20 and a part of the outer surface 53 of the film portion 51. Specifically, the conductor paste is applied to two portions of the film portion 51 covering the first end surface 22A of the base body 20 and a part of four side surfaces 22C on the first positive direction X1 side of the base body 20, and the film portion 51 covering the second end surface 22B of the base body 20 and a part of four side surfaces 22C on the first negative direction X2 side of the base body 20. In the present embodiment, the conductor paste contains silver grains and an organic resin.

Next, the conductor curing step S20 is performed. In the conductor curing step S20, the base body 20 to which the conductor paste is applied is heated to cure the conductor paste. In the present embodiment, heating is performed at about 200° C. The first base electrode 61A and the second base electrode 62A are formed by firing the conductor paste applied in the conductor applying step S19.

Next, the plating step S21 is performed. In the plating step S21, electroplating is performed to form the first metal layer 61B on the surface of the first base electrode 61A. In addition, the second metal layer 62B is formed on the surface of the second base electrode 62A. Although not illustrated, the first metal layer 61B and the second metal layer 62B are electroplated with two kinds of nickel and tin to form a two-layer structure. In this way, the electronic component 10 is formed.

### Effects of the Present Embodiment

(1) According to the above configuration, the protective material 50 is glass containing a silane compound. Since this silane compound has a carbon chain with 3 or more carbon atoms, glass easily enters the voids 23 inside the base body 20 in the process of manufacturing the protective material 50. As a result, the protective material 50 includes not only the film portion 51 covering the outer surface 21 of the base body 20 but also the filling portion 52 filled in the voids 23. As described above, when the filling portion 52, which is a part of the protective material 50, is filled in the voids 23 of the base body 20, cracks and the like can be prevented from occurring in the base body 20 with the void 23 in the base body 20 as a starting point.
(2) In the above embodiment, the thickness T of the film portion 51 is 20 nm or more and 1000 nm or less. When the thickness T of the film portion 51 is smaller than 20 nm, there is a possibility that the adhesion between the film portion 51 and the first external electrode 61 and the second external electrode 62 becomes insufficient. On the other hand, when the thickness T of the film portion 51 is larger than 1000 nm, the difference between the temperature of the outer surface 53 of the film portion 51 and the temperature of the surface of the film portion 51 on the base body 20 side may increase when firing the film portion 51. Therefore, there may be a difference in the degree of firing between the outer surface 53 of the film portion 51 and the surface of the film portion 51 on the base body 20 side. Therefore, when the thickness T of the film portion 51 is 20 nm or more and 1000 nm or less, sufficient adhesion between the first external electrode 61 and the second external electrode 62 can be obtained, and uniform firing is easily performed.
(3) In the above embodiment, the porosity is 0.5% or more and 2.5% or less. With such a degree of porosity, substantially all the voids 23 can be filled with the filling portion 52 of the protective material 50 in the manufacturing method of the above embodiment. Therefore, a special process, a special manufacturing facility, or the like is not required to form the filling portion 52 filled in the voids 23.
(4) In the above embodiment, the arithmetic average roughness of the outer surface 53 of the film portion 51 is 6 nm or more and 100 nm or less. When the arithmetic average roughness of the outer surface 53 of the film portion 51 is less than 6 nm, an anchor effect is less likely to occur between the film portion 51 and the first external electrode 61 and the second external electrode 62, and sufficient adhesion may not be obtained. On the other hand, in a case where the arithmetic average roughness of the outer surface 53 of the film portion 51 is larger than 100 nm, a frictional force is likely to be generated on the outer surface 53 of the film portion 51, and there is a possibility that breakage due to friction occurs. Therefore, when the arithmetic average roughness of the outer surface 53 of the film portion 51 is 6 nm or more and 100 nm or less, sufficient adhesion can be obtained, and breakage due to friction hardly occurs.
(5) In the above embodiment, the filling portion 52 fills the void 23 existing at the position closest to the geometric center GC of the base body 20. That is, it can be considered that the protective material 50 fills substantially all of the voids 23 of the base body 20. When the voids 23 are sufficiently filled in this manner, the effect of improving the strength of the base body 20 can be reliably obtained.
(6) According to the above embodiment, the method for manufacturing the electronic component 10 includes a solution charging step S16 and a protective material forming step S17. The film portion 51 and the filling portion 52 can be formed by charging the metal alkoxide 84 and the silane compound 85 having a carbon chain with 3 or more carbon atoms. Therefore, the strength of the base body 20 can be improved without significantly changing the existing manufacturing method.
(7) According to the above embodiment, in the solution charging step S16 or the protective material forming step S17, the silane compound 85 has one or more functional groups selected from an epoxy group, a mercapto group, an amino group, a vinyl group, and a methacrylic group. The silane compound 85 having these functional groups is relatively easily available and also easily generated. Therefore, manufacturing is easy.
(8) According to the above embodiment, in the solution charging step S16, GPTMS is charged into the reaction vessel 81 at a weight ratio of 0.12 or more and less than 1 to TEOS. By charging GPTMS to TEOS at the above ratio, the protective material 50 can be easily formed into a film while sufficiently obtaining the effect of reducing the rate of the condensation polymerization reaction of TEOS.
(9) According to the above embodiment, the method for manufacturing the electronic component 10 includes a conductor applying step S19 and a conductor curing step S20. The conductor paste contains a resin as a material. Therefore, the first external electrode 61 and the second external electrode 62 contain resin. That is, the first external electrode 61 and the second external electrode 62 are resin electrodes. The resin electrode can be fired at a lower temperature than a metal electrode including silver or the like. Therefore, the energy cost required for firing can be reduced. In addition, since the material of the protective material 50 is a so-called organic-inorganic hybrid, high adhesion of each external electrode to the film portion 51 can be obtained.
(10) According to the above embodiment, the filling portion 52 and the film portion 51 can be formed by firing at a temperature of 140 degrees or more and 160 degrees or less. As a result, a material having lower heat resistance than a material such as ceramics can be used as the material of the base body 20. Therefore, the selectivity of the material of the base body 20 is enhanced. In addition, the energy cost required for firing can be reduced.

### Modification Examples

The above-mentioned embodiment and the following modification examples can be implemented in combination within a range that is not technically contradictory.
The electronic component 10 is not limited to a negative characteristic thermistor component. For example, if some wiring is provided inside the base body 20, a thermistor component other than the negative characteristic may be used, or a laminated capacitor component or an inductor component may be used.
The material of the base body 20 is not limited to the example of the embodiment. In addition, the material of the base body 20 is not limited to the sintered body and can be applied as long as it has a void inside. For example, the material of the base body 20 may be a composite body of a resin and a metal powder, a fiber, a thermosetting resin, or the like.
The shape of the base body 20 is not limited to the example of the embodiment. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.
In the outer surface 21 of the base body 20, a boundary portion between the adjacent planes 22 may not have a chamfered shape. In this case, there is no curved surface at the boundary portion.
The shapes of the first internal electrode 41 and the second internal electrode 42 are not limited as long as they can ensure electrical conduction with the corresponding first external electrode 61 and second external electrode 62. The number of the first internal electrodes 41 and the number of the second internal electrodes 42 are not limited, and the number of the internal electrodes may be one or may be three or more.
The configuration of the first external electrode 61 is not limited to the example of the embodiment. For example, the first external electrode 61 may include only the first base electrode 61A, or the first metal layer 61B does not necessarily have a two-layer structure. In this respect, the same applies to the second external electrode 62.
The materials of the first internal electrode 41, the second internal electrode 42, the first external electrode 61, and the second external electrode 62 are not limited. It is only necessary to ensure electrical conduction between the first internal electrode 41 and the second internal electrode 42, and the corresponding first external electrode 61 and second external electrode 62. For example, the material of the first internal electrode 41 and the second internal electrode 42 may be a conductive material such as silver or copper. The materials of the first external electrode 61 and the second external electrode 62 may not be resin electrodes. For example, an electrode including a mixture of silver and glass containing no resin may be used. In the first external electrode 61 and the second external electrode 62, the material of the conductive filler to be mixed with the resin is not limited to silver. For example, it may be copper.
The arrangement place of the first external electrode 61 is not limited to the example of the embodiment. For example, the first external electrode 61 may be disposed only on the first end surface 22A and one side surface 22C. In this respect, the same applies to the second external electrode 62.
The protective material 50 does not need to cover the entire region of the outer surface 21 of the base body 20. The range covered by the protective material 50 may be appropriately changed in accordance with the shape of the base body 20, the positions of the first external electrode 61 and the second external electrode 62, and the like.
In a portion of the protective material 50 covered with the first base electrode 61A, the glass included in the protective material 50 may diffuse into the glass in the first base electrode 61A. That is, the protective material 50 and the glass included in the first base electrode 61A may be integrated. In this respect, the same applies to the second base electrode 62A.
The average value of the thickness T of the film portion 51 may be less than 20 nm or greater than 1000 nm. By having the protective material 50 at any thickness T, the strength of the base body 20 can be improved as compared with the case of not having the protective material.
The arithmetic average roughness of the outer surface 53 of the film portion 51 may be less than 6 nm or greater than 100 nm. The arithmetic average roughness of the outer surface 53 of the film portion 51 can be appropriately changed according to the dimensions of the electronic component 10, the strength required for the electronic component 10, and the like.
When the arithmetic average roughness of the outer surface 53 of the film portion 51 and the arithmetic average roughness of the outer surface 21 of the base body 20 are measured, devices such as a laser microscope, an atomic force microscope, and a stylus profiling system may be used instead of the white interference method.
The filling portion 52 does not need to fill the void 23 at the position closest to the geometric center GC of the base body 20. That is, the filling portion 52 may fill at least a part of the voids 23 of the base body 20.
The filling rate may be less than 0.5% or more than 2.5%. In other words, when it is assumed that the filling portion 52 fills substantially all the voids 23, the porosity may be less than 0.5% or greater than 2.5%. If the porosity is small, the effect of (1) can be obtained more or less as long as the filling portion 52 fills the voids 23. In addition, if the porosity is large, all the voids 23 can be filled with the filling portion 52 depending on the conditions of the solution charging step S16 and the protective material forming step S17.
The solvent 82 to be charged in the solvent charging step S13 is not limited to the example of the above embodiment, and may be any liquid as long as the liquid can disperse the metal alkoxide 84 accordingly.
The solvent charging step S13 may be performed after the catalyst charging step S14 and the base body charging step S15. The solvent charging step S13 may be performed before at least one of the solution charging step S16 and the catalyst charging step S14. In addition, the solvent charging step S13 may be omitted. In this case, for example, if the amount of water contained in the aqueous solution 83 containing the catalyst is correspondingly large, the metal alkoxide 84 reacts in the liquid phase. In addition, the aqueous solution 83 containing the catalyst may be charged in a state of being mixed with an organic solvent as the solvent 82.
The aqueous solution 83 containing the catalyst is ammonia water, and the catalyst is a hydroxide ion, but the catalyst is not limited thereto. When the aqueous solution is a basic aqueous solution, the hydrolysis of the metal alkoxide 84 as a catalyst can be promoted similarly to the ammonia water of the above embodiment. In addition, an acidic aqueous solution can promote the hydrolysis of the metal alkoxide 84 as a catalyst. Furthermore, a neutral aqueous solution may contain a substance functioning as a catalyst, such as an ion capable of promoting hydrolysis.
Although it has been described that the catalyst is charged as the aqueous solution 83 containing the catalyst, a solid compound containing the catalyst and water may be separately charged into the reaction vessel 81. In this case, it can be considered that the catalyst is charged into the reaction vessel 81 because the catalyst is generated in the reaction vessel 81. In addition, for example, a solid compound containing a catalyst may be charged into the reaction vessel 81, and moisture in the air may be used as water required for hydrolysis.
The base body charging step S15 may be performed before the catalyst charging step S14. When the base body charging step S15 is performed before the catalyst charging step S14, the solution charging step S16 may be performed before the catalyst charging step S14 or the base body charging step S15. At least the base body charging step S15 may be performed before any one of the solution charging step S16 and the catalyst charging step S14.
In the method for manufacturing the electronic component 10 according to the above embodiment, a solution containing a precursor for generating the metal alkoxide 84 may be charged instead of the metal alkoxide 84. In this case, in the solution charging step S16, a metal complex or acetate as a metal alkoxide precursor may be charged.

Examples of the metal complex include acetylacetonates such as lithium acetylacetonate, titanium (IV) oxyacetylacetonate, titanium diisopropoxide bis (acetylacetonate), zirconium (IV) trifluoroacetylacetonate, zirconium (IV) acetylacetonate, aluminum acetylacetonate, aluminum (III) acetylacetonate, calcium (II) acetylacetonate, and zinc (II) acetylacetonate. Examples of the acetate include zirconium acetate, zirconium acetate hydroxide (IV), and basic aluminum acetate.
In the solution charging step S16, the metal alkoxide 84 may be generated in the reaction vessel 81 without being charged into the reaction vessel 81 after the metal alkoxide 84 is generated outside the reaction vessel 81. For example, the metal alkoxide 84 is generated by a reaction between a metal salt and an alcohol. Therefore, it can also be considered that the metal alkoxide 84 is charged into the reaction vessel 81 by the fact that the metal salt as the metal alkoxide precursor and the alcohol are charged into the reaction vessel 81 and the metal alkoxide 84 is generated by the reaction of the metal salt and the alcohol.
The metal alkoxide 84 is not limited to TEOS. For example, titanium, zirconium, aluminum, or the like may be used for the metal contained in the metal alkoxide 84. When the metal contained in the metal alkoxide 84 is silicon, the reaction rate is lower than that of other metals, so that the reaction rate of the metal alkoxide 84 is easily controlled to be constant. As the alkoxy group of the metal alkoxide 84, a methoxy group, a propoxy group, or the like may be used, or a functional group such as a long-chain alkyl group or an epoxy group may be modified like a coupling agent. Furthermore, the coordination number with respect to the metal contained in the metal alkoxide 84 is not limited to four coordination, and may be three coordination or two coordination.
The silane compound 85 is not limited to GPTMS as long as it has a carbon chain with 3 or more carbon atoms. The silane compound 85 does not need to have any of an epoxy group, a mercapto group, an amino group, a vinyl group, and a methacrylic group. For example, the silane compound 85 may be a silane compound such as 3-aminopropyltrimethoxysilane, 3-aminopropyltriethoxysilane, 3-(2-aminoethyl) aminopropyltrimethoxysilane, 3-phenylaminopropyltrimethoxysilane, (3-glycidoxypropyl) methyldimethoxysilane, 3-methacryloxypropyltrimethoxysilane, 3-methacryloxypropylmethyldimethoxysilane, 3-mercaptopropyltrimethoxysilane, n-propyltrimethoxysilane, isobutyltrimethoxysilane, n-hexyltrimethoxysilane, or n-decyltrimethoxysilane. In addition, in the protective material 50 subjected to the protective material forming step S17, by using a method such as X-ray photoelectron spectroscopy, Fourier transform infrared spectrophotometer, Raman spectroscopy, or energy dispersive X-ray analysis, it can be specified that the protective material 50 contains the silane compound 85.
In the solution charging step S16, the order of charging the metal alkoxide 84 and the silane compound 85 is not limited. In addition, a solution obtained by mixing the metal alkoxide 84 and the silane compound 85 at a predetermined ratio in advance may be charged into the reaction vessel 81.
In the solution charging step S16, the weight ratio of the silane compound 85 to the metal alkoxide 84 to be charged into the reaction vessel 81 may be less than 0.12 or 1 or more. If the protective material 50 can be formed, the strength of the base body 20 can be improved.
If the protective material 50 can be formed in the protective material forming step S17, the film curing step S17c does not need to be performed after the drying step S17b. For example, in the conductor curing step S20, the protective material 50 may be cured together with the firing of the conductor paste. In that case, it is considered that the conductor curing step S20 and the film curing step S17c are simultaneously performed.
In the film curing step S17c of the protective material forming step S17, the firing temperature of the solution containing the metal alkoxide 84 and the silane compound 85 attached to the outer surface 21 of the base body 20 may be lower than 140 degrees or higher than 160 degrees. If the firing temperature is high, the protective material 50 can be formed by using a material having high heat resistance such as ceramics as the material of the base body 20.
In the internal electrode exposing step S18, the method of removing the film portion 51 is not limited to laser cutting. For example, the first internal electrode 41 and the second internal electrode 42 may be exposed using a method such as ion milling or polishing.
In the internal electrode exposing step S18, if the first internal electrode 41 and the second internal electrode 42, and the corresponding first base electrode 61A and second base electrode 62A are electrically conducted, the range in which the film portion 51 is removed is not limited to the example of the above embodiment.
The conductor curing step S20 is not limited to heating of the conductor paste. For example, when a material cured by ultraviolet irradiation is used as the conductor paste, ultraviolet irradiation may be performed.
The material of the conductor paste is not limited to resin as long as electrical conduction with the first internal electrode 41 and the second internal electrode 42 can be secured. When the arithmetic average roughness of the portion to which the conductor paste is applied is large, adhesion due to the anchor effect can be obtained.

### <Supplementary Note>

Technical ideas that can be derived from the above embodiments and modification examples will be described below.
(1) An electronic component comprising:
a base body including a plurality of voids;
a protective material covering a part or a whole of an outer surface of the base body; and
an external electrode covering a part of an outer surface of the protective material, wherein
the protective material is glass containing a silane compound having a carbon chain with 3 or more carbon atoms and includes a filling portion occupying at least some of the voids and a film portion covering the outer surface of the base body.
(2) The electronic component of (1), wherein
an average value of a thickness of the film portion is 20 nm or more and 1000 nm or less.
(3) The electronic component of (1), wherein
a ratio of a total volume of the filling portion to a volume of the base body is 0.5% or more and 2.5% or less.
(4) The electronic component of (1), wherein
an average value of a thickness of the film portion is 20 nm or more and 1000 nm or less, and
a ratio of a total volume of the filling portion to a volume of the base body is 0.5% or more and 2.5% or less.
(5) The electronic component of (1), wherein
an arithmetic average roughness of an outer surface of the film portion is 6 nm or more and 100 nm or less.
(6) The electronic component of (1), wherein
an average value of a thickness of the film portion (53) is 20 nm or more and 1000 nm or less,
a ratio of a total volume of the filling portion to a volume of the base body is 0.5% or more and 2.5% or less, and
an arithmetic average roughness of an outer surface of the film portion is 6 nm or more and 100 nm or less.
(7) The electronic component of (1), wherein
the external electrode contains a resin.
(8) The electronic component of (1), wherein
an average value of a thickness of the film portion (53) is 20 nm or more and 1000 nm or less,
a ratio of a total volume of the filling portion to a volume of the base body is 0.5% or more and 2.5% or less, an arithmetic average roughness of an outer surface of the film portion is 6 nm or more and 100 nm or less, and
the external electrode contains a resin.
(9) The electronic component of (1), wherein
the protective material fills the void at a position closest to a geometric center of the base body.
(10) A method for manufacturing an electronic component, the method comprising:
preparing a base body having a plurality of voids therein;
charging the base body into a reaction vessel;
charging a solution containing a metal alkoxide or a metal alkoxide precursor and a silane compound having a carbon chain with 3 or more carbon atoms into the reaction vessel; and
hydrolyzing and condensation-polymerizing the metal alkoxide on an outer surface of the base body and forming a protective material including a filling portion occupying the plurality of voids and a film portion covering the outer surface of the base body.
(11) The method of (10), wherein
the silane compound has one or more of functional groups selected from an epoxy group, a mercapto group, an amino group, a vinyl group, and a methacrylic group.
(12) The method of (10), wherein
the metal alkoxide is tetraethyl orthosilicate,
the silane compound is 3-glycidoxypropyltrimethoxysilane, and
the silane compound is charged into the reaction vessel at a weight ratio of 0.12 or more and less than 1 to the metal alkoxide.
(13) The method of (10), wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane, and
the silane compound is charged into the reaction vessel at a weight ratio of 0.12 or more and less than 1 to the metal alkoxide.
(14) The method of (10), further comprising:
applying a conductor containing a resin to an outer surface of the film portion after the protective material forming step; and
firing the conductor to form an external electrode.
(15) The method of (10), wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane,
the silane compound is charged into the reaction vessel at a weight ratio of 0.12 or more and less than 1 to the metal alkoxide, and
the method further comprises
   applying a conductor containing a resin to an outer surface of the film portion after the protective material forming step; and
   firing the conductor to form an external electrode.
(16) The method of (10), wherein
in hydrolyzing and condensation-polymerizing the metal alkoxide on an outer surface of the base body, a solution containing the metal alkoxide and the silane compound adhering to the outer surface of the base body is fired at a temperature of 140° C. or more and 160° C. or less.
(17) The method of (10), wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane,
the silane compound is charged into the reaction vessel at a weight ratio of 0.12 or more and less than 1 to the metal alkoxide, and
a solution containing the metal alkoxide and the silane compound adhering to the outer surface of the base body is fired at a temperature of 140° C. or more and 160° C. or less in hydrolyzing and condensation-polymerizing the metal alkoxide on an outer surface of the base body.
(18) An electronic component comprising:
a base body;
glass containing a silane compound having a carbon chain with 3 or more carbon atoms covering a part or a whole of an outer surface of the base body, wherein at least a portion of the glass occupies at least some of a plurality of voids of the base body; and
an electrode covering a part of an outer surface of the glass.
(19) The electronic component of (18), wherein
the silane compound has one or more of functional groups selected from an epoxy group, a mercapto group, an amino group, a vinyl group, and a methacrylic group.
(20) The electronic component of (18), wherein the silane compound is 3-glycidoxypropyltrimethoxysilane.

### DESCRIPTION OF REFERENCE SYMBOLS

10: Electronic component
20: Base body
21: Outer surface
23: Void
50: Protective material
51: Film portion
52: Filling portion
53: Outer surface
T: Thickness

1. An electronic component comprising:
a base body including a plurality of voids;
a protective material covering a part or a whole of an outer surface of the base body; and
an external electrode covering a part of an outer surface of the protective material, wherein
the protective material is glass containing a silane compound having a carbon chain with 3 or more carbon atoms and includes a filling portion occupying at least some of the voids and a film portion covering the outer surface of the base body.

2. The electronic component of claim 1, wherein
an average value of a thickness of the film portion is 20 nm or more and 1000 nm or less.

3. The electronic component of claim 1, wherein
a ratio of a total volume of the filling portion to a volume of the base body is 0.5% or more and 2.5% or less.

4. The electronic component of claim 1, wherein
an average value of a thickness of the film portion is 20 nm or more and 1000 nm or less, and
a ratio of a total volume of the filling portion to a volume of the base body is 0.5% or more and 2.5% or less.

5. The electronic component of claim 1, wherein
an arithmetic average roughness of an outer surface of the film portion is 6 nm or more and 100 nm or less.

6. The electronic component of claim 1, wherein
an average value of a thickness of the film portion (53) is 20 nm or more and 1000 nm or less,
a ratio of a total volume of the filling portion to a volume of the base body is 0.5% or more and 2.5% or less, and
an arithmetic average roughness of an outer surface of the film portion is 6 nm or more and 100 nm or less.

7. The electronic component of claim 1, wherein
the external electrode contains a resin.

8. The electronic component of claim 1, wherein
an average value of a thickness of the film portion (53) is 20 nm or more and 1000 nm or less,
a ratio of a total volume of the filling portion to a volume of the base body is 0.5% or more and 2.5% or less, an arithmetic average roughness of an outer surface of the film portion is 6 nm or more and 100 nm or less, and
the external electrode contains a resin.

9. The electronic component of claim 1, wherein
the protective material fills the void at a position closest to a geometric center of the base body.

10. A method for manufacturing an electronic component, the method comprising:
preparing a base body having a plurality of voids therein;
charging the base body into a reaction vessel;
charging a solution containing a metal alkoxide or a metal alkoxide precursor and a silane compound having a carbon chain with 3 or more carbon atoms into the reaction vessel; and
hydrolyzing and condensation-polymerizing the metal alkoxide on an outer surface of the base body and forming a protective material including a filling portion occupying the plurality of voids and a film portion covering the outer surface of the base body.

11. The method of claim 10, wherein
the silane compound has one or more of functional groups selected from an epoxy group, a mercapto group, an amino group, a vinyl group, and a methacrylic group.

12. The method of claim 10, wherein
the metal alkoxide is tetraethyl orthosilicate,
the silane compound is 3-glycidoxypropyltrimethoxysilane, and
the silane compound is charged into the reaction vessel at a weight ratio of 0.12 or more and less than 1 to the metal alkoxide.

13. The method of claim 10, wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane, and
the silane compound is charged into the reaction vessel at a weight ratio of 0.12 or more and less than 1 to the metal alkoxide.

14. The method of claim 10, further comprising:
applying a conductor containing a resin to an outer surface of the film portion after the protective material forming step; and
firing the conductor to form an external electrode.

15. The method of claim 10, wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane,
the silane compound is charged into the reaction vessel at a weight ratio of 0.12 or more and less than 1 to the metal alkoxide, and
the method further comprises
applying a conductor containing a resin to an outer surface of the film portion after the protective material forming step; and
firing the conductor to form an external electrode.

16. The method of claim 10, wherein
in hydrolyzing and condensation-polymerizing the metal alkoxide on an outer surface of the base body, a solution containing the metal alkoxide and the silane compound adhering to the outer surface of the base body is fired at a temperature of 140° C. or more and 160° C. or less.

17. The method of claim 10, wherein
the silane compound has one or more of functional groups selected from an epoxy group, a mercapto group, an amino group, a vinyl group, and a methacrylic group,
the metal alkoxide is tetraethyl orthosilicate,
the silane compound is 3-glycidoxypropyltrimethoxysilane,
the silane compound is charged into the reaction vessel at a weight ratio of 0.12 or more and less than 1 to the metal alkoxide, and
a solution containing the metal alkoxide and the silane compound adhering to the outer surface of the base body is fired at a temperature of 140° C. or more and 160° C. or less in hydrolyzing and condensation-polymerizing the metal alkoxide on an outer surface of the base body.

18. An electronic component comprising:
a base body;
glass containing a silane compound having a carbon chain with 3 or more carbon atoms covering a part or a whole of an outer surface of the base body, wherein at least a portion of the glass occupies at least some of a plurality of voids of the base body; and
an electrode covering a part of an outer surface of the glass.

19. The electronic component of claim 18, wherein
the silane compound has one or more of functional groups selected from an epoxy group, a mercapto group, an amino group, a vinyl group, and a methacrylic group.

20. The electronic component of claim 18, wherein
the silane compound is 3-glycidoxypropyltrimethoxysilane.
